(19) United States
(12) Patent Application Publication
(10) Pub. No.: US 2018/0113619 A1
(43) Pub. Date: Apr. 26, 2018

(54) PERFORMANCE BALANCING OF HETEROGENEOUS TAPE DRIVES AND CARTRIDGES

(71) Applicant: International Business Machines Corporation, Armonk, NY (US)

(72) Inventors: Kousei Kawamura, Tokyo (JP); Koichi Masuda, Tokyo (JP); Sosuke Matsui, Tokyo (JP); Jun Tanaka, Tokyo (JP); Takahiro Tsuda, Tokyo (JP)

(73) Assignee: International Business Machines Corporation, Armonk, NY (US)

(21) Appl. No.: 15/333,809

(22) Filed: Oct. 25, 2016

(51) Int. Cl. G06F 3/06

(52) U.S. Cl. CPC G06F 3/064; G06F 3/0686; G06F 3/061

(57) ABSTRACT

A method for balancing performance of heterogeneous tape drives and/or tape cartridges includes identifying multiple tape cartridges to which data is to be written, and identifying multiple tape drives to write the data to the tape cartridges. The method divides the data into multiple blocks, where each block is configured to be written to one of the multiple tape cartridges by one of the multiple tape drives. The method further sizes each block in accordance with an amount of time required to write the block to the corresponding tape cartridge by the corresponding tape drive. In certain embodiments, the blocks are sized so that they take substantially the same amount of time to be written to their corresponding tape cartridges. Once the blocks are sized appropriately, the method writes the blocks to their corresponding tape cartridges. A corresponding system and computer program product are also disclosed.

### BACKGROUND

### Field of the Invention

This invention relates to systems and methods for balancing performance of heterogeneous tape drives and tape cartridges.

### Background of the Invention

Virtual tape systems, such as the IBM TS7700 and Oracle VTL, and disk storage systems incorporating a file system, such as the IBM Spectrum Scale, support functionality referred to as Hierarchical Storage Management (hereinafter simply referred to as HSM). HSM is a storage technology that is configured to efficiently manage multiple tiers of storage media by migrating or placing more frequently accessed data on storage media that is expensive but supports higher access speeds, while migrating or placing less frequently accessed data on inexpensive storage media with lower access speeds. For example, the IBM TS7700 is designed to manage two tiers of storage, namely a disk storage tier and a tape storage tier, such that more frequently accessed data is placed on the disk storage tier and less frequently accessed data is placed on the tape storage tier.

The IBM TS7700 manages virtual tapes as files and supports virtual tapes with sizes up to 25 Gigabytes. With the possibility of such large virtual tapes, it can take a significant amount of time to move virtual tape files between a disk storage tier and a tape storage tier. As a countermeasure to such time-consuming data transfers, large files may be “striped” across multiple tape cartridges to improve I/O performance. Using this technique, a file is divided into multiple blocks and these blocks are transferred to or from the tape cartridges in parallel. While similar techniques are used on arrays of disk drives to increase data access rates, these techniques are not as simple or efficient to implement on append-only storage media such as tape.

In view of the foregoing, what are needed are systems and methods to stripe data across multiple tape cartridges in a way that is efficient and takes into account the unique characteristics of append-only storage media. Ideally, such systems and methods may be used to efficiently stripe data across tape using heterogeneous tape cartridges and tape drives.

### SUMMARY

The invention has been developed in response to the present state of the art and, in particular, in response to the problems and needs in the art that have not yet been fully solved by currently available systems and methods. Accordingly, systems and methods are disclosed to balance performance of heterogeneous tape drives and/or tape cartridges. The features and advantages of the invention will become more fully apparent from the following description and appended claims, or may be learned by practice of the invention as set forth hereinafter.

Consistent with the foregoing, a method for balancing performance of heterogeneous tape drives and/or tape cartridges is disclosed. In one embodiment, such a method includes identifying a plurality of tape cartridges to which data is to be written, and identifying a plurality of tape drives to write the data to the tape cartridges. The method divides the data into a plurality of blocks, where each block is configured to be written to one of the plurality of tape cartridges by one of the plurality of tape drives. The method further sizes each block in accordance with an amount of time required to write the block to the corresponding tape cartridge by the corresponding tape drive. In certain embodiments, the blocks are sized so that they take substantially the same amount of time to be written to their corresponding tape cartridges. Once the blocks are sized appropriately, the method writes the blocks to their corresponding tape cartridges.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which a system and method in accordance with the invention may be implemented;

FIG. 2 is a high-level block diagram showing “striping” of data across magnetic tape using multiple tape drives and tape cartridges;

FIG. 3 is a high-level block diagram showing “striping” of data across magnetic tape using tape drives and tape cartridges that have the same or similar performance characteristics and end-of-data offsets;

FIG. 4 is a specification table showing various tape drives and tape cartridges that have different performance characteristics;

FIG. 5 is a high-level block diagram showing “striping” of data across magnetic tape using tape drives and tape cartridges that have different performance characteristics and end-of-data offsets;

FIG. 6A is an equation showing one method for calculating an amount of time required to write a data block of a given size to a particular tape cartridge using a particular tape drive;

FIG. 6B is a system of equations that may be used to calculate a size of each block of data that is written to multiple tape cartridges using multiple tape drives, where each block takes substantially the same amount of time to be written to its corresponding tape cartridge by its corresponding tape drive;

FIG. 7A shows one example of a physical volume table that keeps tracks of tape cartridge types, tape cartridge formats, and end-of-data offsets associated with particular physical volumes;

FIG. 7B shows one example of a logical volume mapping table that keeps track of which physical volumes and portions thereof make up a logical volume; and

FIG. 8 is a process flow diagram showing one embodiment of a method for balancing performance of heterogeneous tape drives and/or tape cartridges when striping data across the tape cartridges.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

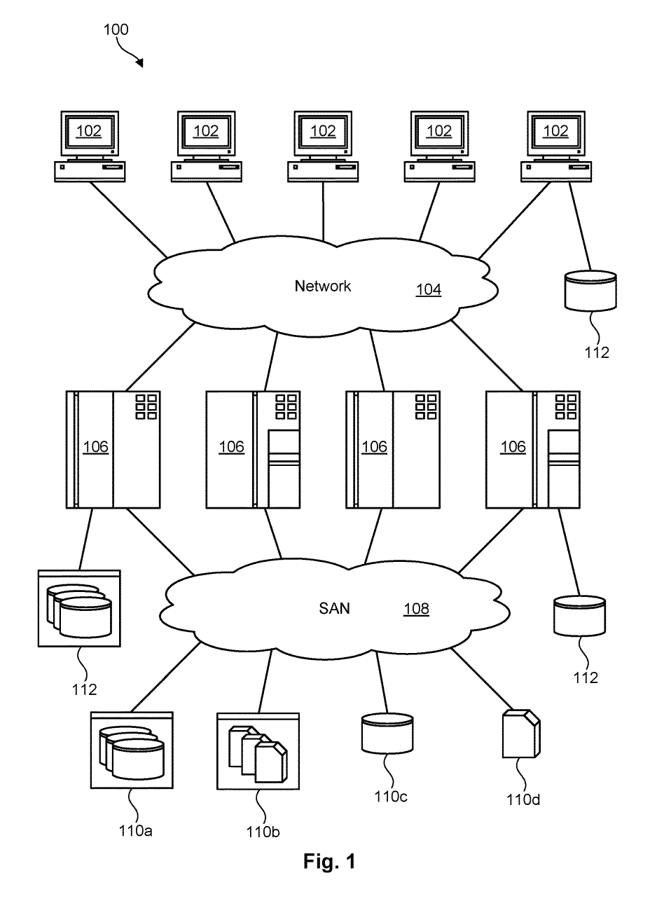

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b or virtual tape systems 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

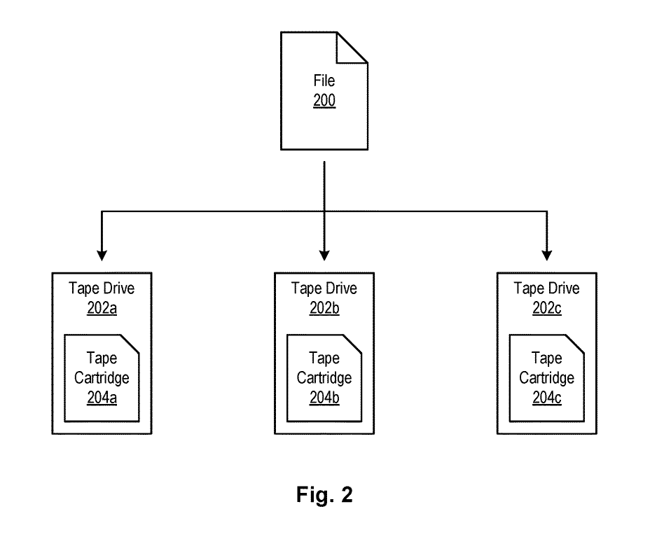

Referring to FIG. 2, as previously mentioned, virtual tape systems 110b such as IBMs TS7700 may be configured to manage very large virtual tapes with sizes up to 25 Gigabytes. With such large virtual tapes, moving virtual tape files between a disk storage tier and a tape storage tier may take a significant amount of time. As a countermeasure to such time-consuming data transfers, large files 200 may be “striped” across multiple tape cartridges 204 to improve I/O performance. The term “tape cartridge” is used broadly herein to include cassettes and other types of containers, housings, and casings containing tape storage media. Using the “striping” technique, a file 200 is divided into multiple blocks and these blocks are transferred to or from the tape cartridges 204 in parallel by multiple tape drives 202. While similar techniques are used on arrays of disk drives to increase data access rates, these techniques are not as simple or efficient to implement on append-only storage media such as tape.

When data is striped across multiple disk drives having different data transfer rates, the disk drive whose data transfer rate is the lowest becomes a bottleneck in completing the write. In this context, the simplest approach to reduce the amount of time required for writing is to adjust the block size written to each of the disk drives in accordance with the data transfer rates of the disk drives. However, additional factors may need to be considered with append-only storage media such as tape. For example, when striping data across multiple tape cartridges 204, the amount of time required to move a head of a tape drive 202 to an appropriate location on tape and the time required to mount a tape cartridge 204 in a tape drive 202 may also need to be considered. Also relevant is the fact that different tape drives 202 may have different data transfer rates depending on the type and format of the tape cartridge 204 that is mounted in the tape drive 202.

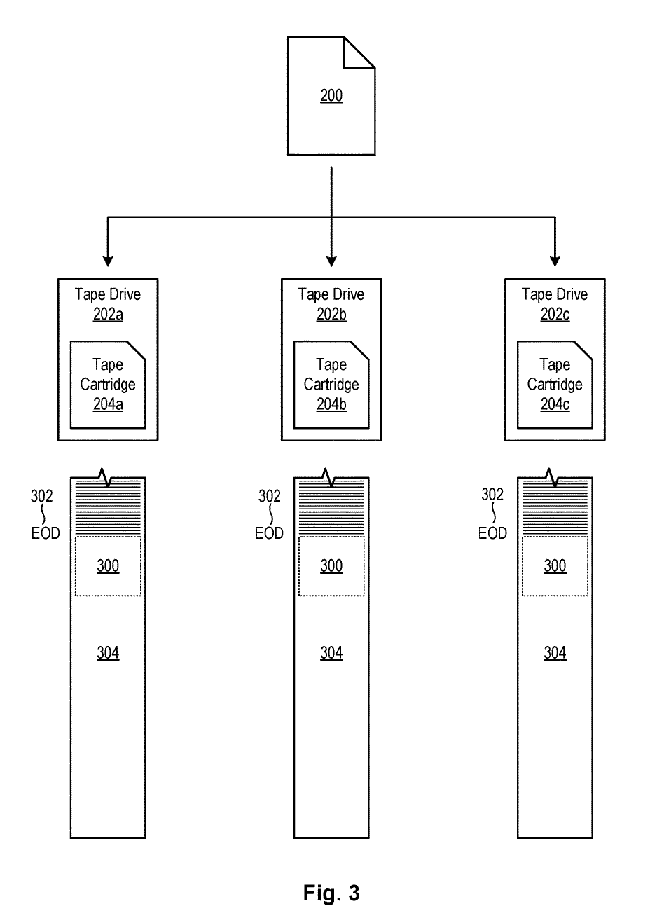

Referring to FIG. 3, when a file 200 is striped across multiple tape drives 202 and tape cartridges 204 having similar performance characteristics (e.g., data transfer rates, seek performance, etc.), and the end-of-data offset 302 is similar on the tape 304 of each tape cartridge 204 being read from or written to, the file 200 may be broken into blocks 300 of similar size since it may take a similar amount of time to write the blocks 300 to the tape cartridges 204. These blocks 300 may be written to the tape cartridges 204 in parallel to improve I/O performance. Because the tape drives 202 and tape cartridges 204 have similar performance characteristics, the tape drives 202 and tape cartridges 204 may operate at or near their full potential when writing data and none of the tape drives 202 or tape cartridges 204 may act as a bottleneck. The equally-sized blocks 300 shown in FIG. 3 are illustrated in a conceptual manner and are not intended to represent the configuration or format that data is actually written to the underlying magnetic tape medium 304.

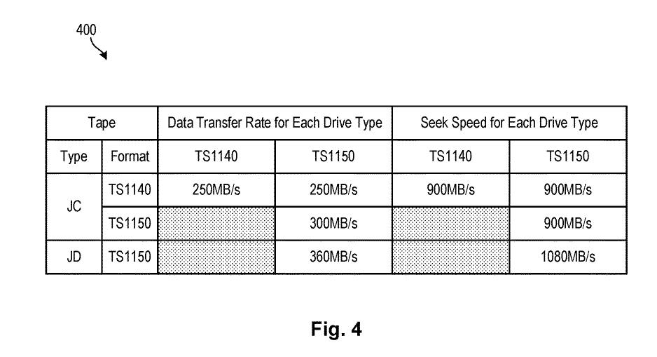

Referring to FIG. 4, unfortunately, use of tape drives 202 and tape cartridges 204 having similar performance characteristics is not always possible or desirable. In many situations, a tape storage environment may include tape drives 202 and tape cartridges 204 having different performance characteristics. This may occur as a matter of design choice or as a result of equipment in a virtual tape system 110b being replaced, upgraded, and/or expanded over time. Thus a tape storage environment may in certain cases be heterogeneous as opposed to homogeneous. Furthermore, the end-of-data offset on each of the tape cartridges 204 may not be the same for all tape cartridges 204 being read from or written to, causing further variations in the amount of time required to write to a tape cartridge 204. In other words, variations in the end-of-data offset on each tape cartridge 204 may create differences in the amount of time that is required to seek to a desired location on the tape 304 and write data at the location.

FIG. 4 is a specification table 400 showing various heterogeneous tape drives 202 and tape cartridges 204 that may be used by a virtual tape system 110b. The specification table 400 may, in certain embodiments, be maintained and referenced by a virtual tape system 110b in accordance with the invention. The specification table 400 shows two types of tape cartridges 204 (JC and JD) and two types of tape drives 202 (TS1140 and TS1150). As further shown, the JC tape cartridge 204 may be formatted for either the TS1140 or TS1150 tape drive 202. The data transfer rate and seek speed associated with each of the TS1140 and TS1150 tape drives 202 is illustrated for each of the tape cartridges 204. As shown, the data transfer rate and seek speed may differ significantly depending on the type of the tape drive 202 and tape cartridge 204 that is used.

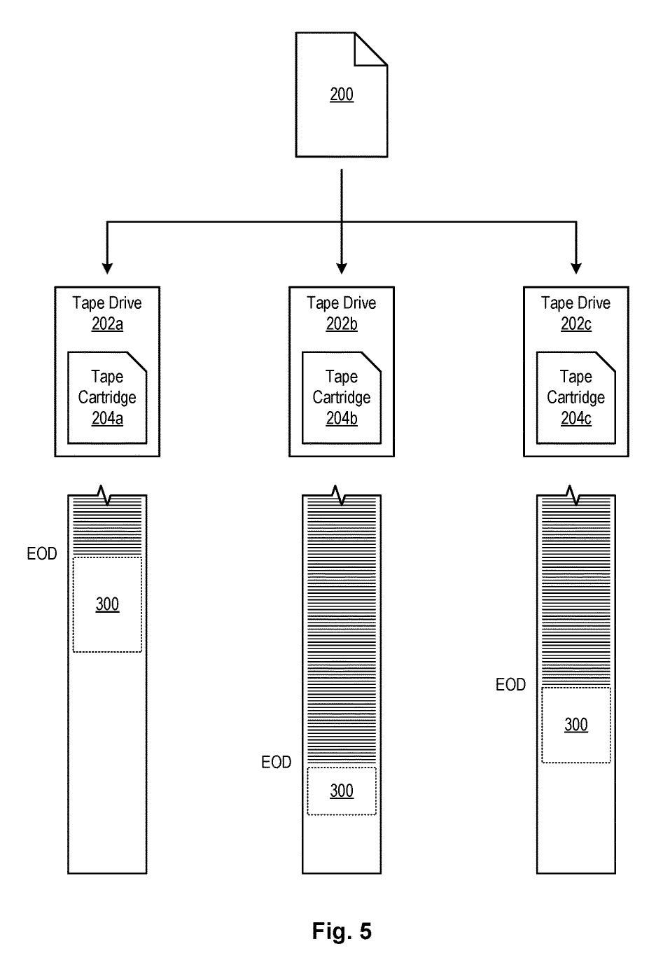

Referring to FIG. 5, when striping a file 200 or other data 200 across a heterogeneous set of tape drives 202 and tape cartridges 204, systems and methods in accordance with the invention may divide the file 200 into blocks 300 of differing size. The size of a block 300 may be tailored in accordance with the amount of time required to write the block 300 to its corresponding tape cartridge 204. In certain embodiments, the blocks 300 may be designed to take substantially the same amount of time to be written to their corresponding tape cartridges 204. In this way, when the blocks 300 are written in parallel, no tape drive 202 or tape cartridge 204 will act as a bottleneck to slow down other tape drives 202 and tape cartridges 204 to complete the write of the file 200. To size the blocks 300 accordingly, systems and methods in accordance with the invention may take into account one or more of a data transfer rate associated with the corresponding tape cartridge 204 and tape drive 202; seek speed of the corresponding tape cartridge 204 and tape drive 202; time required to mount the corresponding tape cartridge 204 in the corresponding tape drive 202; and an offset where the block is to be written to tape 304 of the corresponding tape cartridge 204.

As shown in FIG. 5, when taking into account these factors, blocks 300 of different sizes may be written to the tape cartridges 204, possibly at different locations on the magnetic tape medium 304. Writing of these blocks 300 may be completed at substantially the same time, thereby improving I/O performance when writing the file 200 to the tape cartridges 204. The same or similar performance gains may also be achieved when reading the blocks 300 from the tape cartridges 204. Specifically, when reading the blocks 300 from the tape cartridges 204, each tape drive 202 may finish reading its respective block 300 at substantially the same time to regenerate the file 200.

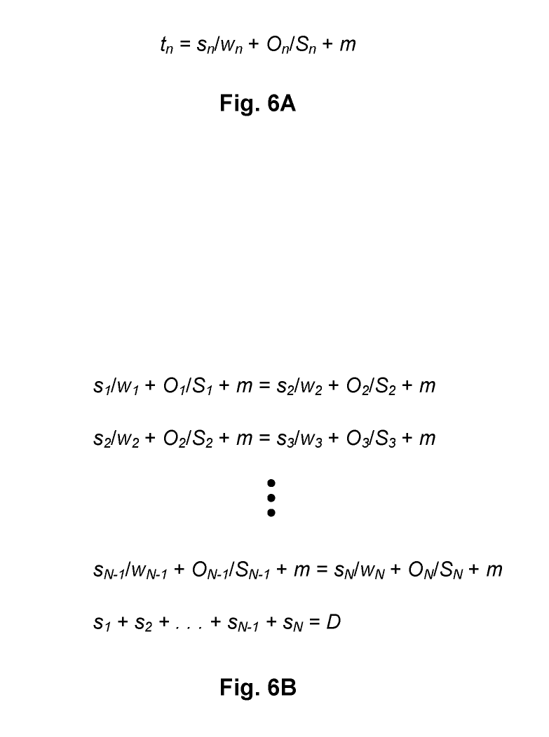

FIGS. 6A and 6B show various equations that may be used to calculate the correct block size. FIG. 6A shows an equation for calculating an amount of time tₙ required to write data to a corresponding tape cartridge 204 (i.e., the n-th tape cartridge 204) using a corresponding tape drive 202 (i.e., the n-th tape drive 202), where sₙ is the size of the data block 300 being written, wₙ is the data transfer rate of the n-th tape drive 202 when writing to the n-th tape cartridge 204, Oₙ is the offset from the beginning of the tape 304 to the end of the data on the n-th tape cartridge 204, Sₙ is the seek speed of the n-th tape drive 202 when traversing the n-th tape cartridge 204, and m is the time required to mount a tape cartridge 204 in a tape drive 202.

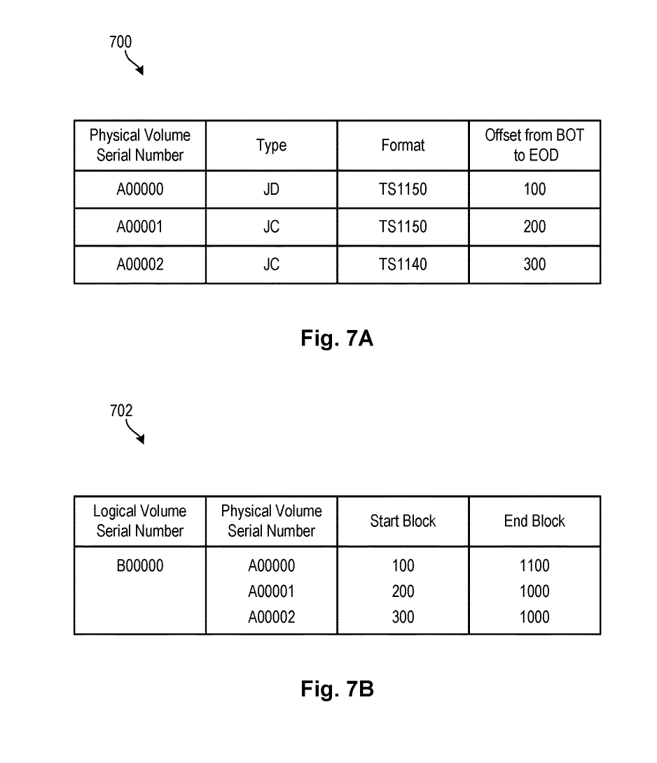

Since the amount of the time required to write a block 300 to all of the tape cartridges 204 (i.e., tape cartridges n=1, 2, . . . , N) is ideally the same, a system of equations may be used to solve for the block size for each tape cartridge 204. Specifically, the system of equations shown in FIG. 6B may be used to calculate the block size sₙ for each block 300 written to the tape cartridges 204, where D is the size of the data (i.e., file 200) that is being striped across the n tape cartridges 204. Because the number of variables and equations is N, the equations may be readily solved for s₁, s₂, . . . , s_{N}. The number N of blocks 300 will generally be the number of tape drives 202 installed in a virtual tape system 110b, although this is not mandatory. When calculating the block sizes, a virtual tape system 110b in accordance with the invention may pull the values wₙ, Oₙ, Sn from the specification table 400 previously described in FIG. 4, and the physical volume table 700 that will be described in association with FIG. 7A. The mount time m may be an average time required to mount a tape cartridge 204 in a tape drive 202 of the virtual tape system 110b. Alternatively, the mount time m may be different for each tape cartridge 204 and/or tape drive 202. In certain cases, a tape cartridge 204 may already be mounted when data is written thereto, in which case m may be zero for the particular tape drive 202 and tape cartridge 204.

Referring to FIGS. 7A and 7B, a virtual tape system 110b in accordance with the invention may, in certain embodiments, maintain one or more of a physical volume table 700 and logical volume mapping table 702. The physical volume table 700 may document physical tape volumes (i.e., tape cartridges 204) that are used on the virtual tape system 110b, as well as characteristics (e.g., physical volume serial number, type of physical volume, format of the physical volume, offset from beginning of tape (BOT) to end of tape (EOD), etc.) of the physical tape volumes. The logical volume mapping table 702, by contrast, may document logical volumes on the virtual tape system 110b, as well as information (e.g., logical volume serial number, physical volumes associated with the logical volume, start block and end block of the physical volume storage space that is associated with the logical volume, etc.) associated with the logical volumes. In the illustrated logical volume mapping table 702, a logical volume (B00000) is associated with portions of three physical tape volumes (A00000, A00001, A00002). The starting and ending blocks of the storage space that is associated with the logical volume is also shown. The file 200 shown in FIGS. 2, 3, and 5 may be considered a “logical volume” and the areas on the physical tape volumes where the file 200 is divided and stored may be documented in the logical volume mapping table 702. When the file 200 is read, the logical volume mapping table 702 may be referenced to determine where to retrieve the data.

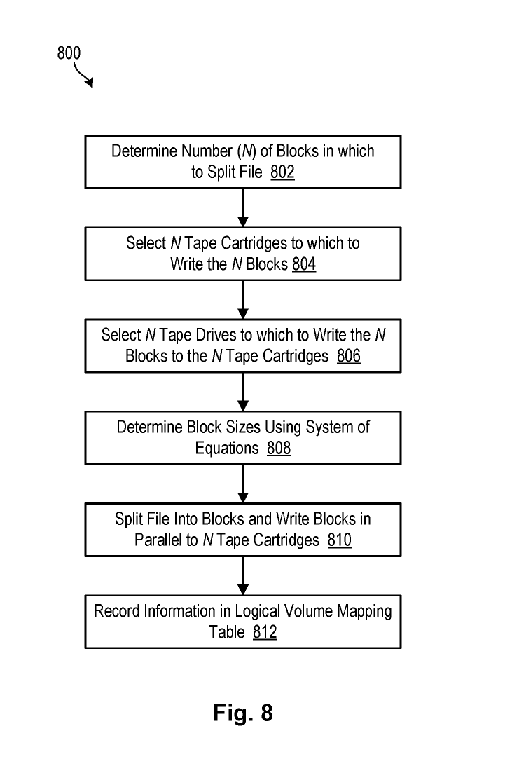

Referring to FIG. 8, one embodiment of a method 800 for balancing performance of heterogeneous tape drives 202 and/or tape cartridges 204 when striping data across the tape cartridges 204, is illustrated. Such a method 800 may be executed by a virtual tape system 110b or other tape management system 110b in accordance with the invention. As shown, when writing a file 200 to tape 304, the method 800 initially determines 802 a number N of blocks 300 in which to split the file 200. In certain embodiments, this may be the number of tape drives 202 in the virtual tape system 110b. The method 800 then selects 804 N tape cartridges 204 to which to write the file 200. In certain embodiments, the virtual tape system 110b may maintain a use history of tape cartridges 204 in the virtual tape system 110b and the virtual tape system 110b may attempt to utilize tape cartridges 204 substantially equally.

The method 800 then selects 806 N tape drives 202 to which to write the file 200 to the N tape cartridges 204. As mentioned above, this may in certain embodiments be all the functioning tape drives 202 in the virtual tape system 110b. The method 800 then determines 808 the sizes of the blocks to be written to the tape cartridges 204. In certain embodiments, this may be accomplished using a system of equations such as that illustrated in FIG. 6B and data from the specification table 400 and physical volume table 700 previously discussed. Once the sizes of the blocks 300 are determined, the method 800 may split 810 the file 200 into the blocks 300 and write the blocks 300 in parallel to the selected tape cartridges 204 at the end-of-data offsets therein. The method 800 then records 812, in the logical volume mapping table 702, where the file 200 and associated data blocks 300 are stored in the tape cartridges 204. This will allow the blocks 300 to be retrieved and used to reconstruct the file 200 at a later time.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for balancing performance of heterogeneous tape drives and/or tape cartridges, the method comprising:
identifying a plurality of tape cartridges to which data is to be written;
identifying a plurality of tape drives to write the data to the tape cartridges;
dividing the data into a plurality of blocks, wherein each block is configured to be written to one of the plurality of tape cartridges by one of the plurality of tape drives;
sizing each block in accordance with an amount of time required to write the block to the corresponding tape cartridge by the corresponding tape drive; and
writing the blocks to their corresponding tape cartridges.

2. The method of claim 1, wherein sizing each block comprises sizing each block to take a substantially same amount of time to be written to its corresponding tape cartridge.

3. The method of claim 1, wherein sizing each block comprises taking into account a data transfer rate associated with the corresponding tape cartridge and tape drive.

4. The method of claim 1, wherein sizing each block comprises taking into account seek speed of the corresponding tape cartridge and tape drive.

5. The method of claim 1, wherein sizing each block comprises taking into account time required to mount the corresponding tape cartridge in the corresponding tape drive.

6. The method of claim 1, wherein sizing each block comprises taking into account an offset where the block is to be written to tape of the corresponding tape cartridge.

7. The method of claim 1, wherein writing the blocks to their corresponding tape cartridges comprises writing the blocks to their corresponding tape cartridges in parallel.

8. A computer program product for balancing performance of heterogeneous tape drives and/or tape cartridges, the computer program product comprising a computer-readable storage medium having computer-usable program code embodied therein, the computer-usable program code configured to perform the following when executed by at least one processor:
identify a plurality of tape cartridges to which data is to be written;
identify a plurality of tape drives to write the data to the tape cartridges;
divide the data into a plurality of blocks, wherein each block is configured to be written to one of the plurality of tape cartridges by one of the plurality of tape drives;
size each block in accordance with an amount of time required to write the block to the corresponding tape cartridge by the corresponding tape drive; and
write the blocks to their corresponding tape cartridges.

9. The computer program product of claim 8, wherein sizing each block comprises sizing each block to take a substantially same amount of time to be written to its corresponding tape cartridge.

10. The computer program product of claim 8, wherein sizing each block comprises taking into account a data transfer rate associated with the corresponding tape cartridge and tape drive.

11. The computer program product of claim 8, wherein sizing each block comprises taking into account seek speed of the corresponding tape cartridge and tape drive.

12. The computer program product of claim 8, wherein sizing each block comprises taking into account time required to mount the corresponding tape cartridge in the corresponding tape drive.

13. The computer program product of claim 8, wherein sizing each block comprises taking into account an offset where the block is to be written to tape of the corresponding tape cartridge.

14. The computer program product of claim 8, wherein writing the blocks to their corresponding tape cartridges comprises writing the blocks to their corresponding tape cartridges in parallel.

15. A system for balancing performance of heterogeneous tape drives and/or tape cartridges, the system comprising:
at least one processor;
at least one memory device operably coupled to the at least one processor and storing instructions for execution on the at least one processor, the instructions causing the at least one processor to:
identify a plurality of tape cartridges to which data is to be written;
identify a plurality of tape drives to write the data to the tape cartridges;
divide the data into a plurality of blocks, wherein each block is configured to be written to one of the plurality of tape cartridges by one of the plurality of tape drives;
size each block in accordance with an amount of time required to write the block to the corresponding tape cartridge by the corresponding tape drive; and
write the blocks to their corresponding tape cartridges.

16. The system of claim 15, wherein sizing each block comprises sizing each block to take a substantially same amount of time to be written to its corresponding tape cartridge.

17. The system of claim 15, wherein sizing each block comprises taking into account a data transfer rate associated with the corresponding tape cartridge and tape drive.

18. The system of claim 15, wherein sizing each block comprises taking into account seek speed of the corresponding tape cartridge and tape drive.

19. The system of claim 15, wherein sizing each block comprises taking into account time required to mount the corresponding tape cartridge in the corresponding tape drive.

20. The system of claim 15, wherein sizing each block comprises taking into account an offset where the block is to be written to tape of the corresponding tape cartridge.
